(19) United States
(12) Patent Application Publication
(10) Pub. No.: US 2009/0040635 A1
(43) Pub. Date: Feb. 12, 2009

(54) Exterior Side View Mirror Assembly for a Vehicle

(76) Inventor: Fa-Sheng Hung, Taipei (TW)

Correspondence Address: SHOEMAKER AND MATTARE, LTD, 10 POST OFFICE ROAD - SUITE 110, SILVER SPRING, MD, 20910, US

(21) Appl. No.: 11/835,571

(22) Filed: Aug. 8, 2007

(51) Int. Cl. G02B 7/182

(52) U.S. Cl. 359/871

(57) ABSTRACT

An exterior side view mirror assembly for a vehicle includes a cover provided on a side portion of the vehicle; a mirror installed to the cover and arranged to face rearward with respect to the vehicle; and at least a turn signal extended from the cover so as to provide light from the side portion of the vehicle via the turn signal.

### FIELD OF THE INVENTION

The present invention relates to mirrors for use with vehicles, and more particularly, to exterior side view mirror assemblies for a vehicle.

### BACKGROUND OF THE INVENTION

Automotive vehicles are typically equipped with an exterior side view mirror assembly. In general, the exterior side view mirror assembly comprises a reflective mirror adapted to provide a rearward field of view of the side lane adjacent the vehicle so as to allow the driver to see whether a side-approaching vehicle is present when the driver is contemplating a lane change. However, even with such mirrors, drivers may still have difficulty seeing nearby vehicles, objects and pedestrians in some regions depending on the driver's position in the driver's seat and the location of the external objects. Such regions are commonly referred to as “blind spots”. For example, the angles between 90 degrees and 170 degrees from the forward direction of a vehicle, i.e., to the immediate right and left of the driver and slightly behind the driver, are common problematic blind spots. This presents a potential safety hazard as the driver, upon checking the view in the side view mirror assembly and seeing no overtaking vehicle therein, may deem it safe to makes a turn or initiate a lane change, unaware that there is a vehicle immediately adjacent at flank or in a blind-spot of the side view mirror assembly.

To reduce the likelihood of collisions, an exterior side view mirror assembly equipped with LED turn signal has been proposed to help in the above situation. The LED turn signal includes at least one LED light bank and is attached to the frame of the side view mirror assembly on the far side of the vehicle door. By blinking the LED turn signal in response to a control signal asserted from a control mechanism, the light provided by the LED turn signal is slightly outward, so that drivers at a side in the blind spot of a driver with a vehicle so equipped will receive a warning.

However, the LED turn signal of this type of side view mirror assembly would be largely obscured by the surface of the reflective mirror. When the LED turn signal of this side view mirror assembly mounted upon a leading vehicle is activated, the driver of a trailing vehicle that is momentarily located in the leading vehicle's side blind spot area may not notice the intention of the leading vehicle since the LED turn signal of the leading vehicle is not fully visible to the driver of trailing vehicle. This can cause the trailing vehicle to be run off the road or to collide with another vehicle located on the opposite side of the trailing vehicle because the driver of the trailing vehicle was not alerted in time to take evasive action, such as honking or slowing.

Further, by using the conventional exterior side view mirror assembly or the above-mentioned exterior side view mirror assembly with the LED turn signal, the driver of the leading vehicle may inadvertently steer into an adjacent lane where the vehicle in front is located or may veer towards the vehicle that is approaching from the side or rearward without being aware of other vehicles in close proximity to the side of the leading vehicle. As a result, accidents and near accidents occur because drivers, relying upon the above conventional exterior side view mirror assembly, are unable to see or to be seen by the mirror(s).

Moreover, the above-mentioned exterior side view mirror assembly with the LED turn signal is only suitable for new car manufacture. Thus, this conventional design is not readily adaptable for retrofitting onto existing vehicles.

Also, the LED turn signal can emit light on the mirror, which is likely to cause distraction or temporarily impaired vision. That is, the use of LED turn signal will cause glare and consequently reduce the driver's vision. Thus, this conventional design increases the risk of accidents.

### SUMMARY OF THE INVENTION

In light of the above prior-art drawbacks, a primary objective of the present invention is to provide an exterior side view mirror assembly for a vehicle that can effectively improve visibility between vehicles and enhance safe operation of the vehicle on which the mirror assembly is installed, with a consequent increase in safety for vehicles nearby.

Another objective of the present invention is to provide an exterior side view mirror assembly for a vehicle that can effectively provide a simplified mirror assembly.

A further objective of the present invention is to provide an exterior side view mirror assembly for a vehicle that can be incorporated into new car manufacture or readily installed on existing vehicles.

A further objective of the present invention is to provide an exterior side view mirror assembly for a vehicle that can decrease glare.

In accordance with the foregoing and other objectives, the present invention proposes an exterior side view mirror assembly for a vehicle.

According to one version of the invention, the exterior side view mirror assembly comprises: a cover installed on a side portion of the vehicle; a mirror installed to the cover and arranged to face rearward with respect to the vehicle; a first turn signal extended from the cover and arranged to face forward with respect to the vehicle; and a second turn signal extended from the cover and arranged to face rearward with respect to the vehicle.

According to another version of the invention, an exterior side view mirror assembly for a vehicle is provided to cover an existing exterior side view mirror assembly of the vehicle, comprising: a cover provided to hood the existing exterior side view mirror assembly; a reflective mirror installed to the cover and arranged to face rearward with respect to the vehicle; and at least a turn signal extended from the cover. Preferably, there are two turn signals comprising a first turn signal and a second turn signal extended from the cover, wherein the first turn signal is arranged to face forward with respect to the vehicle and the second turn signal is arranged to face rearward with respect to the vehicle. Alternatively, a turn signal can be arranged to emit light over its entirety. More preferably, an anti-glare member is provided for the cover.

According to another version of the invention, the exterior side view mirror assembly for a vehicle comprises: a cover provided on a side portion of the vehicle; a reflective mirror installed to the cover and arranged to face rearward with respect to the vehicle; and a turn signal extended from the cover and arranged to emit light over its entirety. Preferably, an anti-glare member is provided to the cover.

In the invention, the first turn signal is upwardly extended from the top of the cover, and the second turn signal is downwardly extended from the bottom of the cover, so as to provide light from the side portion of the vehicle. Thus, the present invention can utilize an indicator light to alert nearby drivers with a visual warning. In another version of the invention, the first turn signal and the second turn signal both are extended from the cover, the first turn signal disposed correspondingly to the front-side portion of the vehicle and the second turn signal disposed correspondingly to the rear-side portion of the vehicle being formed in one housing. Therefore, air resistance caused by the exterior side view mirror assembly can be reduced.

Compared with the conventional technique, the exterior side view mirror assembly in the present invention can advantageously increase visibility. Accordingly, not only can the danger presented by a driver's traditional blind spots at the rear and sides of the vehicle can be effectively reduced using the exterior side view mirror assembly, but also the front side of the vehicle can be seen more readily with the exterior side view mirror assembly. Therefore, the exterior side view mirror assembly in the present invention enhances a vehicle's visibility in daylight, darkness and other conditions of reduced visibility.

Also, drivers in the vehicles approached thereto can see the light at the front and rear side of the vehicle equipped with the exterior side view mirror assembly in the present invention. Thus, the present invention make changing lanes or making a turn easier and less dangerous due to effectively improved conspicuity.

Further, since the first turn signal and the second turn signal both extended from the cover can be integrated with the cover or separated from it, the present invention is suitable for both new car manufacture and for retrofitting existing vehicles.

### BRIEF DESCRIPTION OF THE DRAWINGS

The object, features, and advantages of the present invention can be more fully understood by reading the following detailed description of the preferred embodiments, with reference made to the accompanying drawings, wherein:

FIG. 1A is a top view illustrating two instances of the first embodiment of exterior side view mirror assembly of the present invention installed on a vehicle, one on the left side and one on the right;

FIG. 1B is a top-front view illustrating the structure of the exterior side view mirror assembly of the first embodiment;

FIG. 2 is an enlarged view illustrating the cover of the present invention in the first embodiment;

FIG. 3 is a cross-sectional view illustrating a turn signal of one exterior side view mirror assembly according to the present invention in the first embodiment;

FIG. 4 is a perspective view progressively illustrating the operation using the exterior side view mirror assembly according to the present invention;

FIG. 5A is a representative view illustrating the second embodiment of the exterior side view mirror assembly according to the present invention;

FIG. 5B is a cross-sectional view illustrating a first turn signal and a second turn signal of the exterior side view mirror assembly of FIG. 5A;

FIG. 6 is a perspective view illustrating the exterior side view mirror assembly of FIG. 5A in operation;

FIG. 7A is a perspective view illustrating the third embodiment of the exterior side view mirror assembly according to the present invention;

FIG. 7B is a perspective view illustrating a modification of the third embodiment;

FIG. 8 is a cross-sectional view illustrating the fourth embodiment of the exterior side view mirror assembly according to the present invention; and

FIG. 9 is a cross-sectional view illustrating the fifth embodiment of the exterior side view mirror assembly according to the present invention.

### DETAILED DESCRIPTION OF THE PREFERRED EMBODIMENTS

Preferred embodiments of an exterior side view mirror assembly for a vehicle proposed in the present invention are described in detail as follows.

### First Embodiment

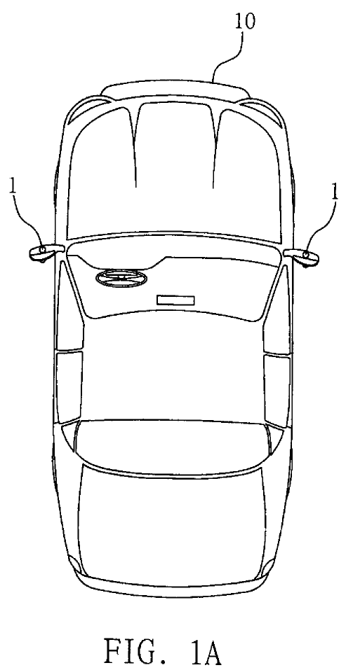

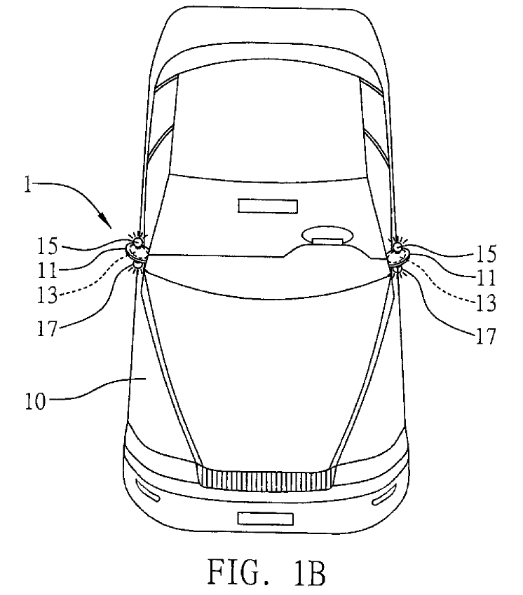

A first embodiment in which the exterior side view mirror assembly is provided for the vehicle is described with reference to FIGS. 1A to FIG. 4. The word “vehicle” is intended to mean any type of vehicle, but, for the sake of simplicity, the invention will be described in connection with an automobile.

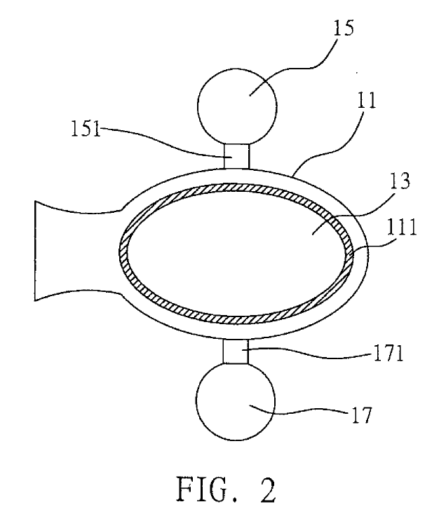

Referring to FIG. 1A, FIG 1B and FIG. 2, two exterior side view mirror assemblies 1 of the present invention are shown installed on the right and the left of a vehicle 10. Each exterior side view mirror assembly 1 comprises a cover 11 installed on a side portion of the vehicle 10, a reflective mirror 13 installed to the cover 11 and arranged to face rearward with respect to the vehicle 10, a first turn signal 15 extended upward from the cover 11 and arranged to face forward with respect to the vehicle 10, and a second turn signal 17 extended downward from the cover 11 and arranged to face rearward with respect to the vehicle 10. In that the other parts of the vehicle 10 are well known in the art and not a technical feature of the present invention, they are not further described herein.

Referring specifically to FIG. 2, in the present invention, the cover 11 is provided with a rubber mirror frame 111, to which the back surface of the reflective mirror 13 is bonded. A drive mechanism (not shown) used to angularly displace the reflective mirror 13 is provided substantially at the center of the rubber frame 111. These two components 11, 13 comprise the exterior side view mirror in the known prior art.

The first turn signal 15 is upwardly extended from the top of the cover 11 and is connected to the cover 11 by a connecting portion 151. Likewise, the second turn signal 17 is downwardly extended from the bottom of the cover 11 and is connected to the cover 11 by a connecting portion 171. In this particular embodiment, the connecting portion 151 and the connecting portion 171 have a neck-like shape and are integrated with the cover 11 respectively, but in other embodiments, the connecting portion 151 and the connecting portion 171 can be attached with the cover 11 by means of screws (not shown), or, alternately, the connecting portion 151 and the connecting portion 171 can be fixed by rivets, pins, and so on (not shown) rather than screws. Moreover, the connecting portion 151 and the connecting portion 171 may be adhered to the cover 11 with an adhesive or other suitable means in other embodiments.

As such, it is possible that the first turn signal 15 and the second turn signal 17 are available for purchase as separate stand-alone products, respectively. This adds to the design flexibility of the overall assembly and makes retrofitting existing vehicles easier. Therefore, the present invention is suitable for both new car manufacture and retrofitting existing vehicles.

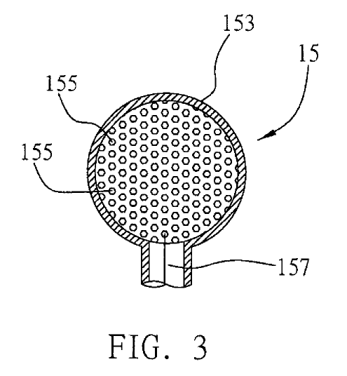

FIG. 3 shows the cross-sectional internal structure of the first turn signal 15 according to the present invention. Note that the structure of the second turn signal 17 would typically be the same as the first turn signal 15. Therefore, the structure of the second turn signal 17 will not to be further described hereafter.

The first turn signal 15 comprises a housing 153 and at least one light source 155 accommodated within the housing 153. The housing 153 can be made of a translucent material, such as glass, plastic, etc, that allows light from the light source 155 to pass. Note that the housing 153 can be partially made of a translucent material as long as light emitted from the light source 155 of the first turn signal 15 can be forwardly emitted and light emitted from the light source (not shown) of the second turn signal 17 can be rearwardly emitted, this particular description not being intended to limit the design. Further, the housing 153 illustrated in FIG. 3 is substantially round in shape. Moreover, in the present embodiment, the first turn signal 15 includes a plurality of light sources 155 electrically connected to a control mechanism (not shown) via an electrical-connecting element 157, and at least one light source 155 can be an electric lamp or a light emitting diode (LED) having a relatively small axial dimension.

The above-mentioned control mechanism for enabling the turn signal is provided at the door frame of the vehicle 10 and is well-known, e.g., see Japanese Unexamined Patent Application Publication No. JP 2001-6495 and U.S. Pat. No. 7,038,580. Since the control mechanism is not a technical feature of the present invention, and the electrical connection structure between the exterior side view mirror assembly 1 and the control mechanism is known, the electrical connection structure therebetween will not to be further described herein.

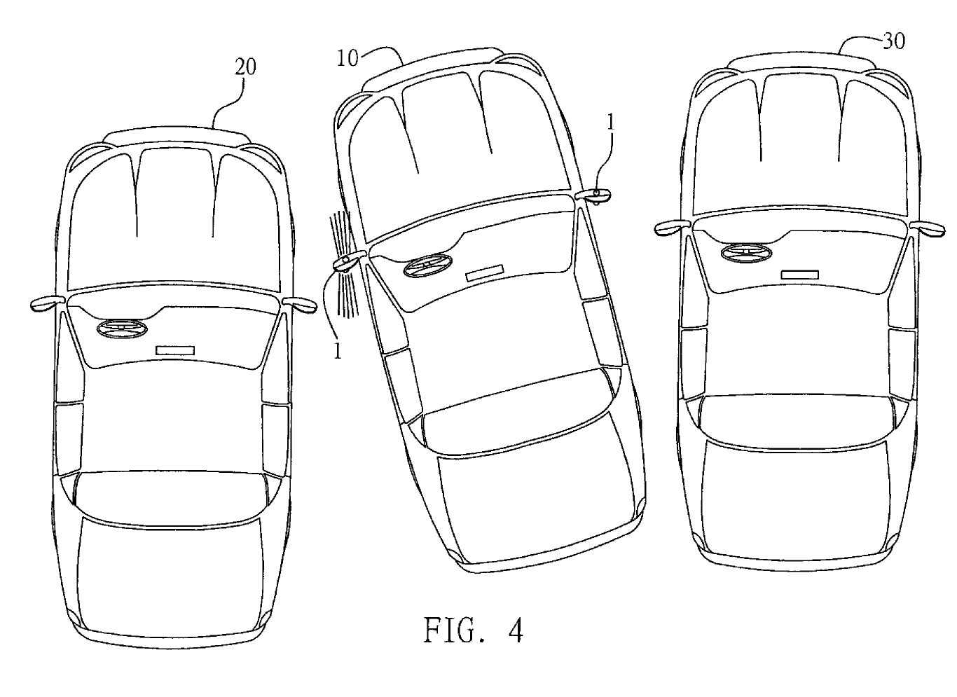

When the vehicle 10 is moving straight ahead, no turn signal is generally activated, except prior to an anticipated lane change or turn. As shown in FIG. 4, when the vehicle 10 is making a left turn, the first turn signal 15 and the second turn signal 17 on the left side of the vehicle thereof can be pulsated or otherwise activated to warn others. In this embodiment, if the vehicle 10 is making a slight left turn, one or a few of the light source(s) 155 are at least partially activated to indicate a left turn with a small degree in response to a control signal asserted from the control mechanism. Correspondingly, if the vehicle 10 is making a sharp turn, all the light sources 155 will be either fully activated or be activated with varying brightness to provide a prominent warning effect. By this way, other drivers in vehicles 20, 30 can timely be informed of the direction the present vehicle 10 is taking or intends to take. Likewise, if the vehicle 10 is making right turn, the first turn signal 15 and the second turn signal 17 on the right side thereof can be activated to warn the drivers on the right side of the vehicle.

In the aforementioned embodiment, the first turn signal 15 is arranged to face forward with respect to the vehicle 10 and the second turn signal 17 is arranged to face rearward with respect to the vehicle 10 so as to provide light toward the front side and rear side of the vehicle 10. That is, the presence of the vehicle 10 can be seen by the first turn signal 15 and the second turn signal 17 from the side. Therefore, this arrangement can effectively improve visibility between vehicles and enhance safe operation of the vehicle on which the mirror assembly is installed, as well as the safety for vehicles traveling in close proximity to the vehicle equipped with the invention.

Alternatively, in another embodiment, in practice, the first turn signal 15 may be arranged to face rearward with respect to the vehicle 10 and the second turn signal 17 may be arranged to face forward with respect to the vehicle 10.

### Second Embodiment

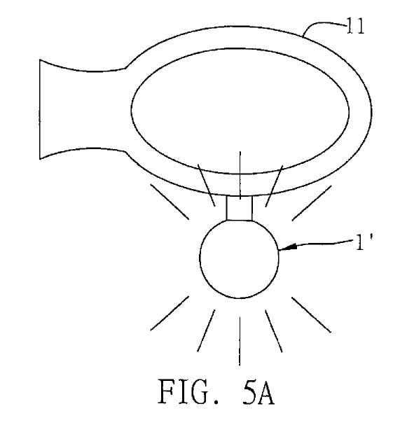

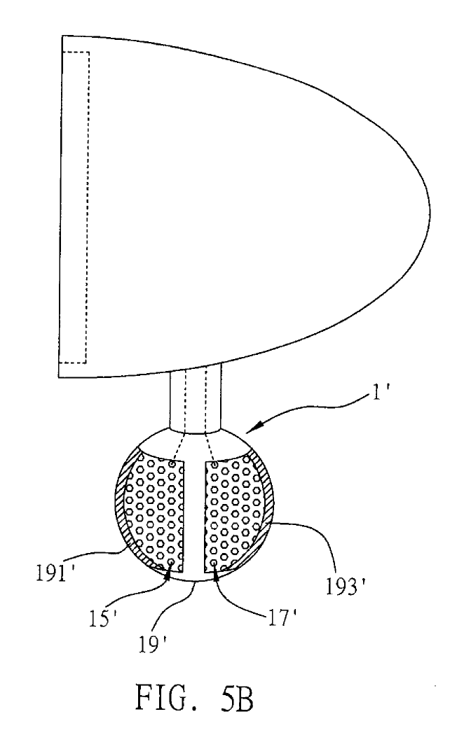

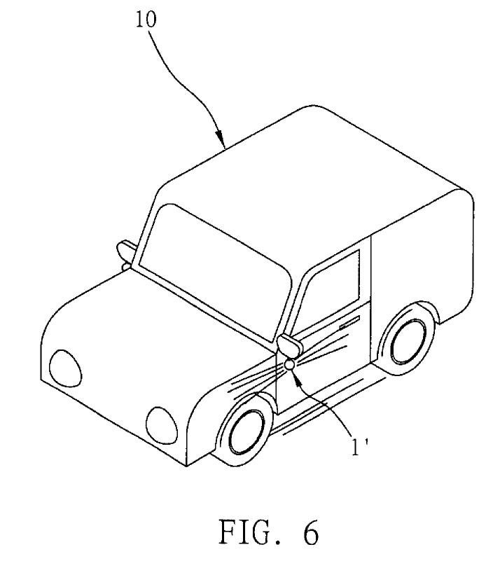

A second embodiment in which the exterior side view mirror assembly is provided for the vehicle is described with reference to FIGS. 5A to FIG. 6. As shown in the drawings, the function of each exterior side view mirror assembly 1′ in the second embodiment is substantially the same as that of the first embodiment, differing only in that, in this embodiment, the first turn signal 15′ and the second turn signal 17′ are both extended from the bottom of the cover 11.

As shown in FIGS. 5A and 5B, a first turn signal 15′ extended from the cover 11 is arranged to face reward with respect to the vehicle 10 and a second turn signal 17′ extended from the cover 11 is arranged to face forward with respect to the vehicle 10, and the first turn signal 15′ and the second turn signal 17′ are oppositely connected in which the back surface of the first turn signal 15′ and the second turn signal 17′ are bonded via an intermediate member.

The first turn signal 15′ and the second turn signal 17′ are accommodated within a housing 19′. The housing 19′ is downwardly extended from the bottom of the cover 11 and is formed with two translucent portions 191′, 193′. The translucent portion 191′ facing reward with respect to the vehicle 10 is connected to the first turn signal 15′ so as to be previous to light emitted reward with respect to the vehicle 10. The translucent portion 193′ facing forward with respect to the vehicle 10 is connected to the second turn signal 17′ so as to be previous to light emitted forward with respect to the vehicle 10. Although the first turn signal and the second turn signal shown in FIGS. 5A and 5B can be mounted in a parallel and spaced-apart relationship, this particular arrangement is not intended as a limitation. For example, the first turn signal and the second turn signal can be integrated into the housing without an intermediate spacing member as shown in FIG. 3.

As shown in FIG. 6, when the vehicle 10 is making left turn, the exterior side view mirror assembly 1′ on the left side thereof can provide light on the left side of the vehicle 10. At the same time, in that the first turn signal 15′ and the second turn signal 17′ are integrated into the same housing 19′, resistance to airflow can be decreased.

### Third Embodiment

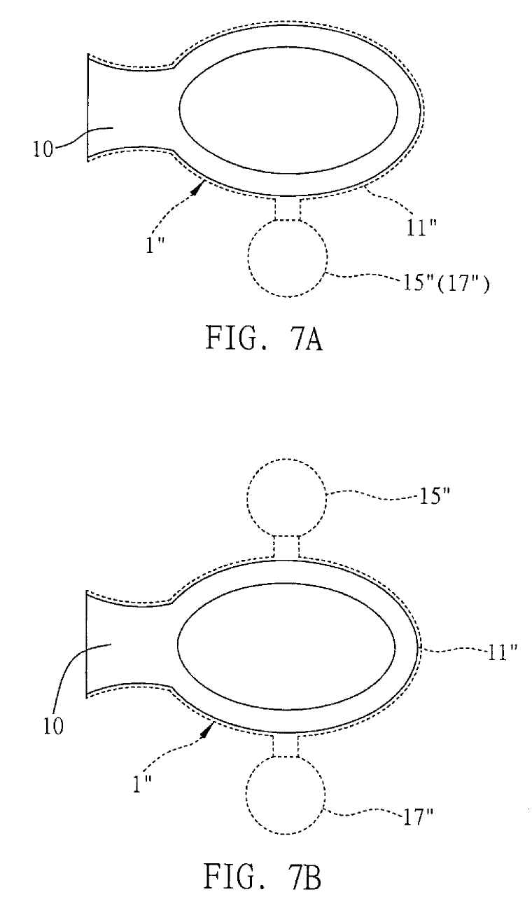

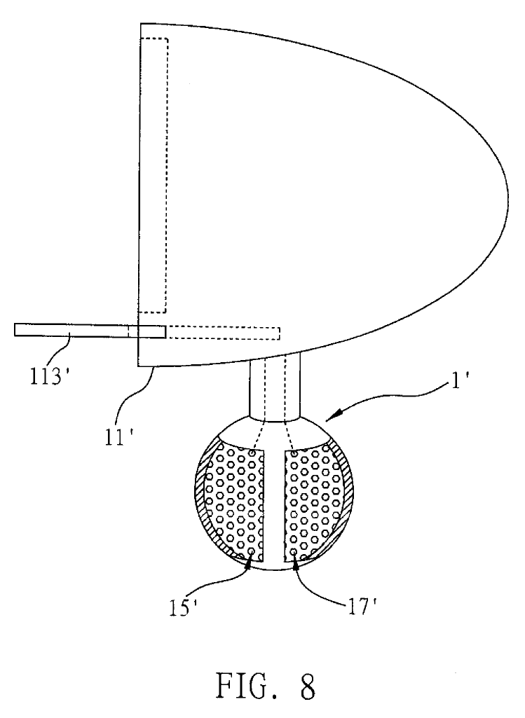

A third embodiment in which the exterior side view mirror assembly is provided for a vehicle is described with reference to FIG. 7A and FIG. 7B. As shown in the drawings, the function of each exterior side view mirror assembly 1″ in the third embodiment is substantially the same as that of the above-mentioned embodiment, differing only in that, in this embodiment, an exterior side view mirror assembly 1″ is provided to cover an existing exterior side view mirror assembly 10 of the vehicle.

As shown in FIG. 7A, a cover 11″ is provided to hood the existing exterior side view mirror assembly 10, and, a first turn signal 15″ and a second turn signal 17″ are both extended from the bottom of the cover 11″. Also, as shown in FIG. 7B, the first turn signal 15″ can be provided to extend upward from the cover 11″ and the second turn signal 17″ can be provided to extend downward from the cover 11″. That is, at least a turn signal accommodated within the housing is extended from the cover in this embodiment.

Therefore, the exterior side view mirror assembly 1″ can be installed or replaced without altering the structure of the exterior side view mirror assembly 10. Thus, the present invention is suitable for existing vehicles

### Fourth Embodiment

A fourth embodiment in which the exterior side view mirror assembly is provided for a vehicle is described with reference to FIG. 8. In this embodiment, the exterior side view mirror assembly further includes an anti-glare member for reducing the presence of glare.

As shown in FIG. 8, an adjustable anti-glare member 113′ is provided to the bottom of the cover 11′ for protecting the driver's eyes from direct light. The anti-glare member 113′ can be telescopically provided from the cover 11′ and be arranged to block light emitted from the first turn signal 15′ and the second turn signal 17′. When the first turn signal 15′ and the second turn signal 17′ are turned on, the control mechanism as mentioned in first embodiment will adjust the anti-glare member 113′ into position, i.e. extend the anti-dazzling member 113′ out, so as to prevent glare caused by the light emitted from the first turn signal 15′ and the second turn signal 17′. Therefore, visibility for the driver equipped with the invention can be improved. Note that in another embodiment an anti-glare film can substitute for the anti-glare member 113′, for example, anti-glare film may be provided on the surface of the reflective mirror installed to the cover. Alternatively, an electrochromic mirror can be used as an anti-glare mirror for vehicles, disclosed, for example, in Japanese Patent Unexamined Publication (JP-A) No. 2000-1895, in which case, the anti-glare member or the anti-glare film may be omitted. As such, any structure or member which can reduce glare is suitable for the invention.

Further, the anti-dazzling member 113′ can be used not only vertically but also horizontally or randomly as long as it blocks the light emitted from the first turn signal 15′ and the second turn signal 17′.

### Fifth Embodiment

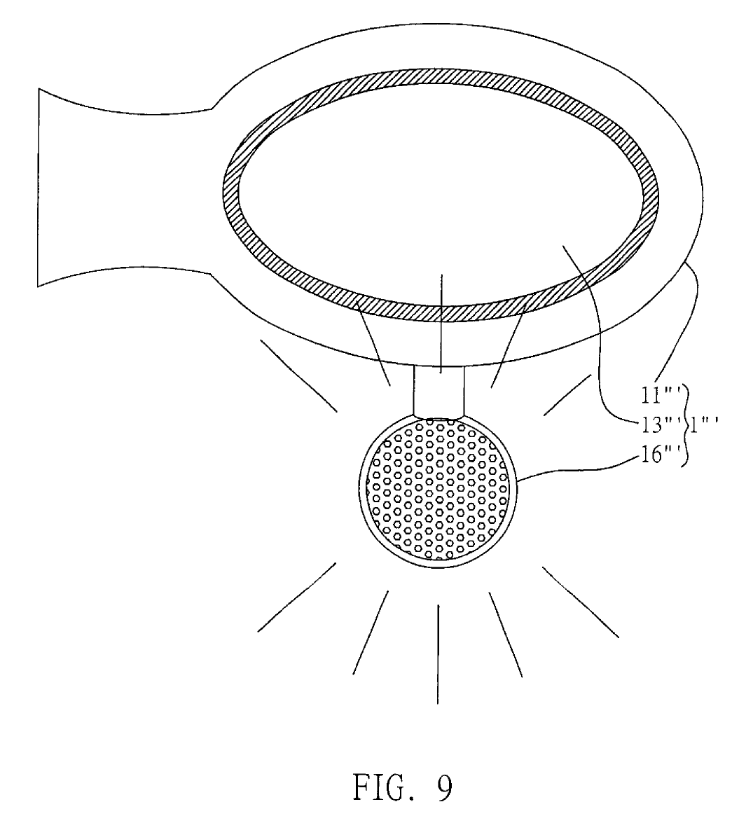

A fifth embodiment in which the exterior side view mirror assembly is provided in the vehicle is described with reference to FIG. 9.

As shown in FIG. 9, the exterior side view mirror assembly 1′″ includes: a cover 11′″ installed on a side portion of the vehicle; a reflective mirror 13′″ installed to the cover 11′″ and arranged to face rearward with respect to the vehicle; and a turn signal 16′″ extended from the cover 11′″ arranged to emit light over its entirety.

In this embodiment, the turn signal 16′″ can emit light in every direction. However, in another embodiment, for example, the turn signal 16′″ can also be arranged to rotate freely like a warning light. In other words, the turn signal 16′″ can be designed to emit multi-directional light or to be rotatable, in order to be conspicuous from every angle.

Compared with the conventional technique, the exterior side view mirror assembly in the present invention can advantageously provide light toward the front side and rear side of a vehicle via the turn signal extended from the side view mirror assembly. Thus, visibility is assured by the light over the entire exterior side of the vehicle. This thereby enhances safe operation of the vehicle. Further, turn signals for providing light toward the front side and rear side of the vehicle can be provided in one housing, such that the structure of an exterior side view mirror assembly can be effectively simplified in the present invention. Also, the exterior side view mirror assembly in the present invention can be incorporated into new car manufacture or readily installed on existing vehicles since the structure of the exterior side view mirror assembly can be composed of separate parts. In addition, since the exterior side view mirror assembly of the present invention can prevent the eyes from being dazzled by stray light, safer driving conditions are provided.

The embodiments provided above are clearly for description purposes and shall not be used to limit the actual scope of the present invention. For example, the shape of the housing of the turn signal is not limited to those shown in figures; other shapes, i.e. rectangle, triangle, etc., also fall in the scope of the present invention. And, in addition to automobiles, other vehicles such as buses, trucks, mini buses, SUVs, vans, trailers and so on may employ the exterior side view mirror assembly of the present invention. Also, depending on actual design choices, the exterior side view mirror assembly illustrated in FIG. 5A and FIG. 5B may be arranged on the top of the cover. In addition, the anti-glare member in FIG. 8 may be arranged according to other embodiments, and the anti-glare member is not limited to be provided in the bottom of the cover. Furthermore, the exterior side view mirror assembly in the third embodiment may use the turn signal of the fifth embodiment.

The invention has been described using exemplary preferred embodiments. However, it is to be understood that the scope of the invention is not limited to the disclosed embodiments. On the contrary, it is intended to cover various modifications and similar arrangements. The scope of the claims therefore should be accorded the broadest interpretation so as to encompass all such modifications and similar arrangements.

1. An exterior side view mirror assembly for a vehicle, comprising:
a cover installed on a side portion of the vehicle;
a reflective mirror being installed to the cover and arranged to face rearward with respect to the vehicle;
a first turn signal extended from the cover and being arranged to face forward with respect to the vehicle; and
a second turn signal extended from the cover and being arranged to face rearward with respect to the vehicle,
wherein the first turn signal is upwardly extended from the top of the cover, and the second turn signal is downwardly extended from the bottom of the cover.

2. The exterior side view mirror assembly of claim 1, wherein the cover is provided with a rubber mirror frame.

3. (canceled)

4. The exterior side view mirror assembly of claim 1, wherein the first turn signal is connected to the cover by a connecting portion, and the second turn signal is connected to the cover by a connecting portion.

5. The exterior side view mirror assembly of claim 4, wherein each connecting portion of the first turn signal and the second turn signal has a neck shape.

6. The exterior side view mirror assembly of claim 4, wherein each connecting portion of the first turn signal and the second turn signal is integrated into the cover.

7. The exterior side view mirror assembly of claim 1, wherein the first turn signal comprises a housing and at least one light source accommodated within the housing.

8. The exterior side view mirror assembly of claim 7, wherein the light source is an electric lamp or a light emitting diode (LED).

9. The exterior side view mirror assembly of claim 1, wherein the second signal comprises a housing and at least one light source accommodated within the housing.

10. The exterior side view mirror assembly of claim 9, wherein the light source is an electric lamp or a light emitting diode (LED).

11. The exterior side view mirror assembly of claim 1, further comprising an antiglare member provided to the cover.

12. An exterior side view mirror assembly for a vehicle, being provided to cover an existing exterior side view mirror assembly of the vehicle, and comprising:
a cover provided to hood the existing exterior side view mirror assembly;
a reflective mirror installed to the cover and arranged to face rearward with respect to the vehicle; and
at least a turn signal extended from the cover, wherein the turn signal is arranged to emit light over its entirety; and
an anti-glare member provided on the cover.

13. The exterior side view mirror assembly of claim 12, wherein the exterior side view mirror assembly is provided with two turn signals comprising a first turn signal and a second turn signal, the first turn signal being arranged to face forward with respect to the vehicle and the second turn signal being arranged to face rearward with respect to the vehicle.

14-15. (canceled)

16. An exterior side view mirror assembly for a vehicle, comprising:
a cover provided on a side portion of the vehicle;
a reflective mirror installed to the cover and arranged to face rearward with respect to the vehicle;
a turn signal extended from the cover and arranged to emit light over its entirety; and
an anti-glare member provided on the cover.

17. (canceled)
